(19) United States
(12) Patent Application Publication
(10) Pub. No.: US 2019/0086923 A1
(43) Pub. Date: Mar. 21, 2019

(54) METHOD AND APPARATUS FOR GENERATING OBSTACLE MOTION INFORMATION FOR AUTONOMOUS VEHICLE

(71) Applicant: Baidu Online Network Technology (Beijing) Co., Ltd., Beijing (CN)

(72) Inventors: Ye Zhang, Beijing (CN); Jun Wang, Beijing (CN); Liang Wang, Beijing (CN)

(21) Appl. No.: 16/050,930

(22) Filed: Jul. 31, 2018

(30) Foreign Application Priority Data
Sep. 18, 2017 (CN) 201710841330.7

(51) Int. Cl. G05D 1/02; G05D 1/00; G06T 7/246; G01S 17/93; G06K 9/00

(52) U.S. Cl. CPC G05D 1/024; G05D 1/0088; G06T 7/248; G06T 2207/30261; G06K 9/00805; G05D 2201/0213; G06T 2207/10028; G01S 17/936

(57) ABSTRACT

An embodiment of the disclosure discloses a method and apparatus for generating obstacle motion information for an autonomous vehicle. An embodiment of the method includes: acquiring an obstacle point cloud in a current frame and the obstacle point cloud in a reference frame characterizing a target obstacle with to-be-generated motion information; calculating a first observed displacement of the target obstacle corresponding to a first observed displacement amount in each of M first observed displacement amounts; determining motion information of the target obstacle corresponding to the first observed displacement amount; determining observed motion information of the target obstacle based on the determined M types of motion information and historical motion information; and generating current motion information of the target obstacle using a preset filtering algorithm with the motion information of the target obstacle as a state variable, and the observed motion information as an observed amount.

### CROSS-REFERENCE TO RELATED APPLICATIONS

This application claims priority to Chinese Patent Application no. 201710841330.7, filed with the State Intellectual Property Office of the People's Republic of China (SIPO) on Sep. 18, 2017, the content of which is incorporated herein by reference in its entirety.

### TECHNICAL FIELD

The disclosure relates to the field of autonomous vehicle technology, specifically to the field of obstacle motion estimation technology, and more specifically to a method and apparatus for generating obstacle motion information for an autonomous vehicle.

### BACKGROUND

An autonomous vehicle, also known as a “robotic car,” comprehensively analyzes and processes information collected by various sensors (e.g., a camera and a lidar) using a driving control device equipped on the vehicle to achieve path planning and driving control. Most autonomous vehicles are provided with lidars to collect information from the outside world. In the process of path planning and driving control, an autonomous vehicle may perform obstacle detection based on a laser point cloud (i.e., laser point cloud collected by the lidar in each sampling period) in each frame collected by the lidar, and then estimate motion of a detected obstacle to achieve obstacle avoidance and perform path planning in advance.

However, the existing method for estimating obstacle motion mostly defines an interest point using an obstacle point cloud (a point cloud characterizing the obstacle), and estimates the obstacle motion based on the interest point, thereby resulting in inaccurate motion estimation in case of inaccurate obstacle point cloud segmentation (e.g., under-segmentation or over-segmentation).

### SUMMARY

An object of an embodiment of the disclosure is to provide a method and apparatus for generating obstacle motion information for an autonomous vehicle, to solve the technical problems mentioned in a part of the Background.

In a first aspect, an embodiment of the disclosure provides a method for generating obstacle motion information for an autonomous vehicle, where the autonomous vehicle is equipped with a lidar, and the method includes: acquiring an obstacle point cloud in a current frame and the obstacle point cloud in a reference frame characterizing a target obstacle with to-be-generated motion information, where the obstacle point cloud in the current frame is obtained based on a current laser point cloud frame collected by the lidar, and the obstacle point cloud in the reference frame is obtained based on a laser point cloud characterizing the target obstacle in a preset number of laser point cloud frames prior to the current laser point cloud frame collected by the lidar; calculating a first observed displacement of the target obstacle corresponding to a first observed displacement amount in each of M first observed displacement amounts based on the obstacle point cloud in the current frame and the obstacle point cloud in the reference frame; determining motion information of the target obstacle corresponding to the first observed displacement amount in the each of the M first observed displacement amounts based on M first observed displacements obtained through calculation and the sampling period of the lidar; determining observed motion information of the target obstacle in accordance with a kinematic rule or a statistical rule based on the determined M types of motion information and historical motion information of the target obstacle; and generating current motion information of the target obstacle using a preset filtering algorithm with the motion information of the target obstacle as a state variable, and the observed motion information as an observed amount.

In some embodiments, before the determining observed motion information of the target obstacle in accordance with a kinematic rule or a statistical rule based on the determined M types of motion information and historical motion information of the target obstacle, the method further includes: determining whether the determined M types of motion information are ambiguous based on the determined M types of motion information and the historical motion information of the target obstacle; and the determining observed motion information of the target obstacle in accordance with a kinematic rule or a statistical rule based on the determined M types of motion information and historical motion information of the target obstacle includes: determining the observed motion information of the target obstacle in accordance with the kinematic rule or the statistical rule based on the determined M types of motion information and the historical motion information of the target obstacle in response to determining the determined M types of motion information being not ambiguous.

In some embodiments, the determining whether the determined M types of motion information are ambiguous based on the determined M types of motion information and the historical motion information of the target obstacle includes: determining, for each type of motion information in the determined M types of motion information, a residual vector between the motion information and motion information of the target obstacle in the last cycle; determining a residual vector with a minimum modulus in the M residual vectors obtained through calculation as a first minimum residual vector; determining the determined M types of motion information being not ambiguous in response to the modulus of the first minimum residual vector being less than a first preset modulus threshold; and determining the determined M types of motion information being ambiguous in response to the modulus of the first minimum residual vector being greater than or equal to the first preset modulus threshold.

In some embodiments, the determining whether the determined M types of motion information are ambiguous based on the determined M types of motion information and the historical motion information of the target obstacle includes: determining, for each type of motion information in the determined M types of motion information, a residual vector between the motion information and motion information of the target obstacle in the last cycle; calculating an average vector of the determined M residual vectors; determining a residual vector with a minimum modulus of a vector difference from the average vector obtained through calculation in the determined M residual vectors as a second minimum residual vector; determining the determined M types of motion information being not ambiguous in response to the modulus of the second minimum residual vector being less than a second preset modulus threshold; and determining the determined M types of motion information being ambiguous in response to the modulus of the second minimum residual vector being greater than or equal to the second preset modulus threshold.

In some embodiments, the determining, for each type of motion information in the determined M types of motion information, a residual vector between the motion information and motion information of the target obstacle in the last cycle includes: determining, for each type of motion information in the determined M types of motion information, a residual vector between the motion information and the motion information of the target obstacle in the last cycle as the residual vector between the motion information and the motion information of the target obstacle in the last cycle.

In some embodiments, the determining, for each type of motion information in the determined M types of motion information, a residual vector between the motion information and motion information of the target obstacle in the last cycle includes: executing for each type of motion information in the determined M types of motion information: generating estimated motion information of the target obstacle using the preset filtering algorithm with the motion information of the target obstacle as a state variable, and the motion information as an observed amount; and determining a differential vector between the generated estimated motion information and the motion information of the target obstacle in the last cycle as the residual vector between the motion information and the motion information of the target obstacle in the last cycle.

In some embodiments, the method further includes: calculating a second observed displacement of the target obstacle corresponding to a second observed displacement amount in each of N second observed displacement amounts based on the obstacle point cloud in the current frame and the obstacle point cloud in the reference frame in response to determining the determined M types of motion information being ambiguous, where the calculation amount of the second observed displacement amount in the each of the N second observed displacement amounts is greater than the calculation amount of the first observed displacement amount in the each of the M first observed displacement amounts; determining motion information of the target obstacle corresponding to the second observed displacement amount in the each of the N second observed displacement amounts based on N second observed displacements obtained through calculation and the sampling period of the lidar; and determining the observed motion information of the target obstacle in accordance with the kinematic rule or the statistical rule based on the determined N types of motion information, the determined M types of motion information and the historical motion information of the target obstacle.

In some embodiments, before the generating current motion information of the target obstacle using a preset filtering algorithm with the motion information of the target obstacle as a state variable, and the observed motion information as an observed amount, the method further includes: determining whether the modulus of a residual vector between the observed motion information and the motion information of the target obstacle in the last cycle is greater than a third preset modulus threshold; and updating the observed motion information using motion information obtained through multiplying the observed motion information by a first ratio in response to determining the modulus of a residual vector between the observed motion information and the motion information of the target obstacle in the last cycle being greater than the third preset modulus threshold, where the first ratio is obtained through dividing the third preset modulus threshold by the modulus of the residual vector between the observed motion information and the motion information of the target obstacle in the last cycle.

In some embodiments, the generating current motion information of the target obstacle using a preset filtering algorithm with the motion information of the target obstacle as a state variable, and the observed motion information as an observed amount includes: adjusting a filtering parameter in the preset filtering algorithm based on a similarity between the obstacle point cloud in the current frame and the obstacle point cloud in the reference frame; and generating current motion information of the target obstacle using the preset filtering algorithm with the adjusted filtering parameter with the motion information of the target obstacle as a state variable, and the observed motion information as an observed amount.

In some embodiments, the motion information includes at least one of: speed information, or acceleration information.

In some embodiments, the M first observed displacement amounts include at least one of: an observed center displacement amount, an observed gravity center displacement amount, an observed edge center displacement amount, or an observed corner displacement amount.

In some embodiments, the N second observed displacement amounts include an observed surface displacement amount.

In a second aspect, an embodiment of the disclosure provides an apparatus for generating obstacle motion information for an autonomous vehicle, where the autonomous vehicle is equipped with a lidar, and the apparatus includes: an acquisition unit configured for acquiring an obstacle point cloud in a current frame and the obstacle point cloud in a reference frame characterizing a target obstacle with to-be-generated motion information, where the obstacle point cloud in the current frame is obtained based on a current laser point cloud frame collected by the lidar, and the obstacle point cloud in the reference frame is obtained based on a laser point cloud characterizing the target obstacle in a preset number of laser point cloud frames prior to the current laser point cloud frame collected by the lidar; a first calculation unit configured for calculating a first observed displacement of the target obstacle corresponding to a first observed displacement amount in each of M first observed displacement amounts based on the obstacle point cloud in the current frame and the obstacle point cloud in the reference frame; a first determination unit configured for determining motion information of the target obstacle corresponding to the first observed displacement amount in the each of the M first observed displacement amounts based on M first observed displacements obtained through calculation and the sampling period of the lidar; a second determination unit configured for determining observed motion information of the target obstacle in accordance with a kinematic rule or a statistical rule based on the determined M types of motion information and historical motion information of the target obstacle; and a generation unit configured for generating current motion information of the target obstacle using a preset filtering algorithm with the motion information of the target obstacle as a state variable, and the observed motion information as an observed amount.

In some embodiments, the apparatus further includes: a second determination unit configured for determining whether the determined M types of motion information are ambiguous based on the determined M types of motion information and the historical motion information of the target obstacle; and the second determination unit is further configured for: determining the observed motion information of the target obstacle in accordance with the kinematic rule or the statistical rule based on the determined M types of motion information and the historical motion information of the target obstacle in response to determining the determined M types of motion information being not ambiguous.

In some embodiments, the second determination unit is further configured for: determining, for each type of motion information in the determined M types of motion information, a residual vector between the motion information and motion information of the target obstacle in the last cycle; determining a residual vector with a minimum modulus in the M residual vectors obtained through calculation as a first minimum residual vector; determining the determined M types of motion information being not ambiguous in response to the modulus of the first minimum residual vector being less than a first preset modulus threshold; and determining the determined M types of motion information being ambiguous in response to the modulus of the first minimum residual vector being greater than or equal to the first preset modulus threshold.

In some embodiments, the second determination unit is further configured for: determining, for each type of motion information in the determined M types of motion information, a residual vector between the motion information and motion information of the target obstacle in the last cycle; calculating an average vector of the determined M residual vectors; determining a residual vector with a minimum modulus of a vector difference from the average vector obtained through calculation in the determined M residual vectors as a second minimum residual vector; determining the determined M types of motion information being not ambiguous in response to the modulus of the second minimum residual vector being less than a second preset modulus threshold; and determining the determined M types of motion information being ambiguous in response to the modulus of the second minimum residual vector being greater than or equal to the second preset modulus threshold.

In some embodiments, the second determination unit is further configured for: determining, for each type of motion information in the determined M types of motion information, a differential vector between the motion information and the motion information of the target obstacle in the last cycle as the residual vector between the motion information and the motion information of the target obstacle in the last cycle.

In some embodiments, the second determination unit is further configured for: executing for each type of motion information in the determined M types of motion information: generating estimated motion information of the target obstacle using the preset filtering algorithm with the motion information of the target obstacle as a state variable, and the motion information as an observed amount; and determining a differential vector between the generated estimated motion information and the motion information of the target obstacle in the last cycle as the residual vector between the motion information and the motion information of the target obstacle in the last cycle.

In some embodiments, the apparatus further includes: a second calculation unit configured for calculating a second observed displacement of the target obstacle corresponding to a second observed displacement amount in each of N second observed displacement amounts based on the obstacle point cloud in the current frame and the obstacle point cloud in the reference frame in response to determining the determined M types of motion information being ambiguous, where the calculation amount of the second observed displacement amount in the each of the N second observed displacement amounts is greater than the calculation amount of the first observed displacement amount in the each of the M first observed displacement amounts; a third determination unit configured for determining motion information of the target obstacle corresponding to the second observed displacement amount in the each of the N second observed displacement amounts based on N second observed displacements obtained through calculation and the sampling period of the lidar; and a fourth determination unit configured for determining the observed motion information of the target obstacle in accordance with the kinematic rule or the statistical rule based on the determined N types of motion information, the determined M types of motion information and the historical motion information of the target obstacle.

In some embodiments, the apparatus further includes a fifth determination unit configured for determining whether the modulus of a residual vector between the observed motion information and the motion information of the target obstacle in the last cycle is greater than a third preset modulus threshold; and an updating unit configured for updating the observed motion information using motion information obtained through multiplying the observed motion information by a first ratio in response to determining the modulus of a residual vector between the observed motion information and the motion information of the target obstacle in the last cycle being greater than the third preset modulus threshold, where the first ratio is obtained through dividing the third preset modulus threshold by the modulus of the residual vector between the observed motion information and the motion information of the target obstacle in the last cycle.

In some embodiments, the generation unit includes: an adjustment module configured for adjusting a filtering parameter in the preset filtering algorithm based on a similarity between the obstacle point cloud in the current frame and the obstacle point cloud in the reference frame; and a generation module configured for generating current motion information of the target obstacle using the preset filtering algorithm with the adjusted filtering parameter with the motion information of the target obstacle as a state variable, and the observed motion information as an observed amount.

In some embodiments, the motion information includes at least one of: speed information, or acceleration information.

In some embodiments, the M first observed displacement amounts include at least one of: an observed center displacement amount, an observed gravity center displacement amount, an observed edge center displacement amount, or an observed corner displacement amount.

In some embodiments, the N second observed displacement amounts include an observed surface displacement amount.

In a third aspect, an embodiment of the disclosure provides a driving control device, and the driving control device includes: one or more processors; and a memory for storing one or more programs, where the one or more programs enable, when executed by the one or more processors, the one or more processors to execute the method according to any one of the implementations in the first aspect.

In a fourth aspect, an embodiment of the disclosure provides a computer readable storage medium storing a computer program therein, wherein the program implements, when executed by a processor, the method according to any one of the implementations in the first aspect.

A method and apparatus for generating obstacle motion information for an autonomous vehicle provided by an embodiment of the disclosure acquire an obstacle point cloud in a current frame and the obstacle point cloud in a reference frame characterizing a target obstacle with to-be-generated motion information, where the obstacle point cloud in the current frame is obtained based on a current laser point cloud frame collected by the lidar, and the obstacle point cloud in the reference frame is obtained based on a laser point cloud characterizing the target obstacle in a preset number of laser point cloud frames prior to the current laser point cloud frame collected by the lidar; calculate a first observed displacement of the target obstacle corresponding to a first observed displacement amount in each of M first observed displacement amounts based on the obstacle point cloud in the current frame and the obstacle point cloud in the reference frame; determine motion information of the target obstacle corresponding to the first observed displacement amount in the each of the M first observed displacement amounts based on M first observed displacements obtained through calculation and a sampling period of the lidar; then determine observed motion information of the target obstacle in accordance with a kinematic rule or a statistical rule based on the determined M types of motion information and historical motion information of the target obstacle; and finally generate current motion information of the target obstacle using a preset filtering algorithm with the motion information of the target obstacle as a state variable, and the observed motion information as an observed amount. Therefore, effective motion estimation of an obstacle may still be achieved even when a point cloud of the obstacle is inaccurately segmented.

### BRIEF DESCRIPTION OF THE DRAWINGS

By reading and referring to detailed description on the non-limiting embodiments in the following accompanying drawings, other features, objects and advantages of the disclosure will become more apparent:

FIG. 1 is a structural diagram of an illustrative system in which the disclosure may be applied;

FIG. 2 is a process diagram of an embodiment of a method for generating obstacle motion information for an autonomous vehicle according to the disclosure;

FIG. 3 is a process diagram of another embodiment of a method for generating obstacle motion information for an autonomous vehicle according to the disclosure;

FIG. 4 is a schematic diagram of a structure of an embodiment of an apparatus for generating obstacle motion information for an autonomous vehicle according to the disclosure; and

FIG. 5 is a schematic diagram of a structure of a computer system suitable for implementing a driving control device according to an embodiment of the disclosure.

### DETAILED DESCRIPTION OF EMBODIMENTS

The present application will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

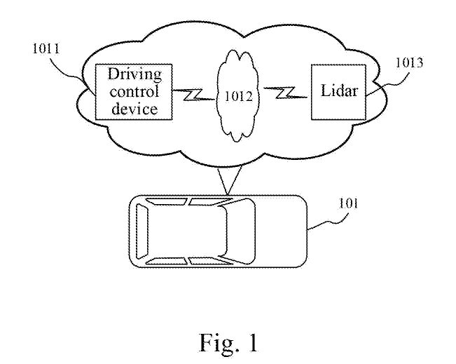

FIG. 1 shows an illustrative system architecture 100 in which an embodiment of a method for generating obstacle motion information for an autonomous vehicle or an apparatus for generating obstacle motion information for an autonomous vehicle according to the disclosure may be applied.

As shown in FIG. 1, the system architecture 100 may include an autonomous vehicle 101.

A driving control device 1011, a network 1012, and a lidar 1013 may be installed on the autonomous vehicle 101. The network 1012 provides a communication link medium between the driving control device 1011 and the lidar 1013. The network 1012 may include a variety of connection types, such as a wired communication link, a wireless communication link, or a fiber cable.

The driving control device (also known as an electronic control unit) 1011 is responsible for intelligent control of the autonomous vehicle 101. The driving control device 1011 may be a separate controller, such as a programmable logic controller (PLC), a single-chip microcomputer or an industrial computer; may also be other equipment having an input/output port and formed by electronic components with operation and control functions, and may also be a computer device on which a vehicle driving control application is installed.

It should be noted that in practice, at least one sensor, e.g., a camera, a gravity sensor, or a wheel speed sensor, may be further installed on the autonomous vehicle 101. In some cases, a GNSS (Global Navigation Satellite System) device, an SINS (Strap-down Inertial Navigation System) or the like may be further installed on the autonomous vehicle 101.

It should be noted that the method for generating obstacle motion information for an autonomous vehicle provided in an embodiment of the disclosure is generally executed by the driving control device 1011. Accordingly, the apparatus for generating obstacle motion information for an autonomous vehicle is generally set in the driving control device 1011.

It should be understood that the numbers of driving control devices, networks, and lidars in FIG. 1 are only illustrative. There may be any number of driving control devices, networks, and lidars according to the practical needs.

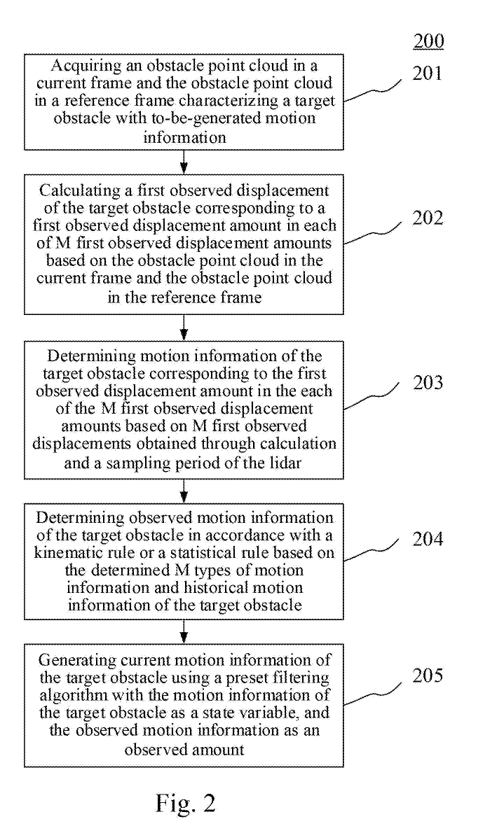

By further referring to FIG. 2, a process 200 of an embodiment of a method for generating obstacle motion information for an autonomous vehicle according to the disclosure is shown. The method for generating obstacle motion information for an autonomous vehicle includes:

Step 201: acquiring an obstacle point cloud in a current frame and the obstacle point cloud in a reference frame characterizing a target obstacle with to-be-generated motion information.

When the autonomous vehicle is running, the lidar installed on the autonomous vehicle may collect information of the outside environment in real time, generate a laser point cloud, and transmit the laser point cloud to an electronic device (for example, the driving control device as shown in FIG. 1) on which the method for generating obstacle motion information for an autonomous vehicle runs. The electronic device may analyze and process the received laser point cloud to identify and track an obstacle in the environment around the vehicle, and predict the running route of the obstacle for path planning and driving control of the vehicle.

First, the electronic device may detect the obstacle based on each of the received laser point cloud frames to distinguish between which laser point data in the laser point cloud describe an obstacle, which laser point data describe a non-obstacle (e.g., a drivable area), and which laser point data describe a given obstacle. The obstacle may include a static obstacle and a moving obstacle. For example, the static obstacle may be a tree, a dropped object, a warning sign, a traffic sign, a road barrier or the like, while the moving obstacle may be a pedestrian, an animal, a vehicle, or the like. Here, the obstacle point cloud may be relevant characteristic information characterizing an obstacle. As an example, the obstacle point cloud may include laser point cloud data or characteristic information of an obstacle extracted based on the laser point cloud data. For example, the characteristic information may include location and length information of a bounding box of an obstacle; length, width, and height information of the obstacle; volume of the obstacle, and the like. Of course, the characteristic information may further include other characteristic information of the obstacle. That is, after receiving each laser point cloud frame, the electronic device needs to detect an obstacle based on the laser point cloud frame, and generate at least one obstacle point cloud characterizing the obstacle.

Then, the electronic device may establish correlation between obstacle point clouds in every two adjacent laser point cloud frames. That is, if two obstacle point clouds characterizing a given obstacle in the physical world exist in the obstacle point clouds detected from two adjacent laser point cloud frames, then correlation between the two obstacle point clouds is established. In practice, the correlation between obstacle point clouds may be realized by relating each obstacle point cloud with an obstacle identifier.

Then, in order to track the obstacle for running path planning when the autonomous vehicle is running, it is necessary to estimate motion of the obstacle. Under the circumstance, the electronic device may acquire the obstacle point cloud in a current frame and the obstacle point cloud in a reference frame characterizing a target obstacle with to-be-generated motion information. The obstacle point cloud in the current frame is obtained based on a current laser point cloud frame collected by the lidar, and the obstacle point cloud in the reference frame is obtained based on a laser point cloud characterizing the target obstacle in a preset number of laser point cloud frames prior to the current laser point cloud frame collected by the lidar. That is, the obstacle point cloud in the current frame is an obstacle point cloud characterizing the target obstacle in the obstacle point cloud obtained by the electronic device through obstacle detection of the current laser point cloud frame collected by the lidar, and the obstacle point cloud in the reference frame is obtained by the electronic device based on the laser point clouds characterizing the target obstacle in a preset number of laser point cloud frames prior to the current laser point cloud frame collected by the lidar. As an example, the obstacle point cloud in the reference frame may be the obstacle point cloud characterizing the target obstacle in the obstacle point cloud obtained through obstacle detection of the laser point cloud frame immediately prior to the current laser point cloud frame collected by the lidar. As an example, the obstacle point cloud in the reference frame may further be an average value of the obstacle point clouds characterizing the target obstacle in the obstacle point clouds obtained through obstacle detection of each laser point cloud frame in a preset number of laser point cloud frames prior to the current laser point cloud frame collected by the lidar. Here, the target obstacle may include a static obstacle and a moving obstacle. In practice, the electronic device may only estimate motion of moving obstacles when estimating motion of target obstacles.

Step 202: calculating a first observed displacement of the target obstacle corresponding to a first observed displacement amount in each of M first observed displacement amounts based on the obstacle point cloud in the current frame and the obstacle point cloud in the reference frame.

In the embodiment, the electronic device may calculate a first observed displacement of the target obstacle corresponding to a first observed displacement amount in each of M first observed displacement amounts based on the obstacle point cloud in the current frame and the obstacle point cloud in the reference frame acquired in the step 201, where M is a positive integer.

Here, the first displacement may be a variety of displacements characterizing spatial displacements of an obstacle, and is not specifically defined in the disclosure.

In some optional implementations of the embodiment, the M first observed displacement amounts may include at least one of: an observed center displacement amount, an observed gravity center displacement amount, an observed edge center displacement amount, or an observed corner displacement amount.

As an example, the calculating a first observed displacement of the target obstacle corresponding to an observed center displacement amount based on the obstacle point cloud in the current frame and the obstacle point cloud in the reference frame may include:

First, the coordinate of the center of the obstacle point cloud in the current frame and the coordinate of the center of the obstacle point cloud in the reference frame are acquired. As an example, when an obstacle point cloud includes a plurality of laser point data, where each of the laser point data includes a 3D or 2D coordinate, the coordinate of the center of the obstacle point cloud may be the 3D or 2D coordinate of the center laser point datum of the obstacle point cloud, where the center laser point datum of the obstacle point cloud is the laser point datum that have a minimum sum of distances from the 3D or 2D coordinate of the laser point datum to all laser point data except the laser point datum in the plurality of laser point data included in the obstacle point cloud, in the plurality of laser point data included in the obstacle point cloud. When the obstacle point cloud includes a 3D or 2D bounding box, which is the smallest circumscribed cuboid of the 3D coordinates or the smallest circumscribed rectangle of the 2D coordinates of the plurality of laser point data included in the obstacle point cloud, the coordinate of the center of the obstacle point cloud may be the coordinate of the geometrical center of the 3D or 2D bounding box included in the obstacle point cloud. When the obstacle point cloud includes a 3D or 2D convex hull, which may be a convex hull of the 3D or 2D coordinates in the laser point data included in the obstacle point cloud, the coordinate of the center of the obstacle point cloud may be the coordinate of the geometrical center of the convex hull included in the obstacle point data.

Then, a first displacement between the coordinate of the center of the obstacle point cloud in the current frame and the coordinate of the center of the obstacle point cloud in the reference frame is calculated. Here, the first displacement may not only include a straight line distance, but also include a displacement in three directions of a 3D space or in two directions of a 2D space.

As an example, the calculating a first observed displacement of the target obstacle corresponding to an observed gravity center displacement amount based on the obstacle point cloud in the current frame and the obstacle point cloud in the reference frame may include:

First, the coordinate of the gravity center of the obstacle point cloud in the current frame and the coordinate of the gravity center of the obstacle point cloud in the reference frame are acquired. As an example, when an obstacle point cloud includes a plurality of laser point data and each of the laser point data includes a 3D or 2D coordinate, the coordinate of the gravity center of the obstacle point cloud may be the 3D or 2D coordinate of the gravity center of the obstacle point cloud, which is the mean value coordinate of the 3D or 2D coordinates of the plurality of laser point data included in the obstacle point cloud. When the obstacle point cloud includes a 3D or 2D bounding box, which is the smallest circumscribed cuboid of the 3D coordinates or the smallest circumscribed rectangle of the 2D coordinates of the plurality of laser point data included in the obstacle point cloud, the coordinate of the gravity center of the obstacle point cloud may be the coordinate of the geometrical center of the 3D or 2D bounding box included in the obstacle point cloud. When the obstacle point cloud includes a 3D or 2D convex hull, which may be a convex hull of the 3D or 2D coordinates in the laser point data included in the obstacle point cloud, the coordinate of the gravity center of the obstacle point cloud may be the coordinate of the geometrical center of the convex hull included in the obstacle point data.

Then, a first displacement between the coordinate of the gravity center of the obstacle point cloud in the current frame and the coordinate of the gravity center of the obstacle point cloud in the reference frame is calculated. Here, the first displacement may not only include a straight line distance, but also include a displacement in three directions of a 3D space or in two directions of a 2D space.

As an example, the calculating a first observed displacement of the target obstacle corresponding to an observed edge center displacement amount based on the obstacle point cloud in the current frame and the obstacle point cloud in the reference frame may include:

First, the coordinate of a specified edge center of the obstacle point cloud in the current frame and the coordinate of the specified edge center of the obstacle point cloud in the reference frame are acquired. As an example, when an obstacle point cloud includes a 3D or 2D bounding box, which is the smallest circumscribed cuboid of the 3D coordinates or the smallest circumscribed rectangle of the 2D coordinates of the plurality of laser point data included in the obstacle point cloud, the coordinate of the edge center of the obstacle point cloud may be the coordinate of the center of a specified edge of the 3D or 2D bounding box included in the obstacle point cloud. When the obstacle point cloud includes a 3D or 2D convex hull, which may be a convex hull of the 3D or 2D coordinates in the laser point data included in the obstacle point cloud, and the coordinate of the edge center of the obstacle point cloud may be the coordinate of the center of the specified edge of the convex hull included in the obstacle point data.

Then, a first displacement between the coordinate of the edge center of the obstacle point cloud in the current frame and the coordinate of the edge center of the obstacle point cloud in the reference frame is calculated. Here, the first displacement may not only include a straight line distance, but also include a displacement in three directions of a 3D space or in two directions of a 2D space.

As an example, the calculating a first observed displacement of the target obstacle corresponding to an observed corner displacement amount based on the obstacle point cloud in the current frame and the obstacle point cloud in the reference frame may include:

First, the coordinate of a corner of the obstacle point cloud in the current frame and the coordinate of the corner of the obstacle point cloud in the reference frame are acquired. As an example, when an obstacle point cloud includes a 3D or 2D bounding box, which is the smallest circumscribed cuboid of the 3D coordinates or the smallest circumscribed rectangle of the 2D coordinates of a plurality of laser point data included in the obstacle point cloud, the coordinate of the corner of the obstacle point cloud may be the coordinate of a specified vertex of the 3D or 2D bounding box included in the obstacle point cloud. When the obstacle point cloud includes a 3D or 2D convex hull, which may be a convex hull of the 3D or 2D coordinates in the laser point data included in the obstacle point cloud, the coordinate of the corner of the obstacle point cloud may be the coordinate of a specified vertex of the convex hull included in the obstacle point data.

Then, a first displacement between the coordinate of the corner of the obstacle point cloud in the current frame and the coordinate of the corner of the obstacle point cloud in the reference frame is calculated. Here, the first displacement may not only include a straight line distance, but also include a displacement in three directions of a 3D space or in two directions of a 2D space.

Step 203: determining motion information of the target obstacle corresponding to the first observed displacement amount in the each of the M first observed displacement amounts based on M first observed displacements obtained through calculation and a sampling period of the lidar.

In the embodiment, the electronic device may determine motion information of the target obstacle corresponding to the first observed displacement amount in the each of the M first observed displacement amounts based on the M first observed displacements obtained through calculation in the step 202 and the sampling period of the lidar. Here, the motion information is information characterizing the motion state of the target obstacle.

Here, the first observed displacement of the target obstacle corresponding to the first observed displacement amount in the each of the M first observed displacement amounts has been obtained in the step 202. Then, for the first observed displacement amount in the each of the M first observed displacement amounts, first the first observed displacement of the target obstacle corresponding to the first observed displacement amount is acquired, and then the motion information of the target obstacle corresponding to the first observed displacement amount is determined based on the acquired first displacement and the sampling period of the lidar. Here, the sampling period of the lidar is the time difference between the moment at which the current laser point cloud frame has been collected by the lidar and the moment at which the laser point cloud frame immediately prior to the current laser point cloud frame has been collected by the lidar, and the M first observed displacements obtained through calculation in the step 202 are also displacements occurring in this period. According to the kinematic rule, the motion information may be determined based on the displacement and the time period.

In some optional implementations of the embodiment, the motion information may include at least one of: speed information, or acceleration information.

Here are illustrations below:

If the first observed displacements of the target obstacle corresponding to the observed center displacement amount, the observed gravity center displacement amount, the observed edge center displacement amount, and the observed corner displacement amount obtained through calculation in the step 202 are respectively: 1 m, 1.2 m, 1.3 m and 1.5 m, and the sampling period of the lidar is 0.1 s, then the speed information of the target obstacle corresponding to the observed center displacement amount, the observed gravity center displacement amount, the observed edge center displacement amount and the observed corner displacement amount may be respectively determined as: 10 m/s, 12 m/s, 13 m/s and 15 m/s.

Then, if speed information of a target obstacle in the last cycle obtained through motion estimation is 9 m/s, i.e., the speed information of the target obstacle generated based on motion estimation in the laser point cloud frame immediately prior to the current laser point cloud frame collected by the lidar is 9 m/s, then here, the acceleration information of the target obstacle corresponding to the observed center displacement amount, the observed gravity center displacement amount, the observed edge center displacement amount and the observed corner displacement amount may be respectively determined as: 10 m/s², 30 m/s², 40 m/s² and 60 m/s² based on the kinematic knowledge.

Step 204: determining observed motion information of the target obstacle in accordance with a kinematic rule or a statistical rule based on the determined M types of motion information and historical motion information of the target obstacle.

In the embodiment, the electronic device may determine observed the motion information of the target obstacle in accordance with a kinematic rule or a statistical rule based on the M types of motion information determined in the step 203 and the historical motion information of the target obstacle.

Here, the historical motion information of the target obstacle is the motion information of the target obstacle obtained by the electronic device through executing the operations in the step 201 to the step 205 based on each of historical laser point cloud frames collected by the lidar prior to collecting the current laser point cloud frame, and the electronic device stores the historical motion information. The historical motion information of the target obstacle characterizes the historical motion state of the target obstacle.

A laser point cloud collected by a lidar suffers from less information, concealment, sparsity in the distance, and the like. Therefore, there is over-segmentation or under-segmentation or the like of an obstacle point cloud obtained through obstacle detection of each of the laser point cloud frames. Under the circumstance, if motion information of the target obstacle is calculated only relying on one observed displacement amount, and if the obstacle point cloud in the current frame and the obstacle point cloud in a reference frame of the target obstacle is inaccurately segmented, the motion information of the target obstacle calculated based on the observed displacement amount will be inaccurate, too. M first observed displacements are calculated in the step 202, in which some first observed displacements may be inaccurate, and some first observed displacements may be accurate. M types of motion information are determined in the step 203. Since the motion of the target obstacle complies with a kinematic rule or a statistical rule, the electronic device may determine observed motion information in accordance with a kinematic rule or a statistical rule based on the determined M types of motion information and historical motion information of the target obstacle. Thus, it is possible to avoid the inaccurate estimation of motion information resulted from only using one observed displacement amount.

In some optional implementations of the embodiment, the electronic device may determine observed motion information of the target obstacle in accordance with a kinematic rule or a statistical rule based on the M types of motion information determined in the step 203 and the historical motion information of the target obstacle. As an example, first, a residual vector between each type of motion information in the determined M types of motion information and motion information of the target obstacle in the last cycle may be determined, and the motion information having a minimum modulus of the vector difference between the selected motion information and the average motion information obtained through calculation may be selected from the M types of motion information as the observed motion information of the target obstacle. Here, the motion information of the target obstacle in the last cycle is the motion information obtained through motion estimation of the target obstacle in the last cycle. The residual vector between each type of motion information in the M types of motion information and the motion information of the target obstacle in the last cycle may be a vector difference between the motion information and the motion information of the target obstacle in the last cycle. The residual vector between each type of motion information in the M types of motion information and the motion information of the target obstacle in the last cycle may also be determined as follows: first generating estimated motion information of the target obstacle using a preset filtering algorithm with the motion information of the target obstacle as a state variable, and the motion information as an observed amount; and then determining a vector difference between the generated estimated motion information and the motion information of the target obstacle in the last cycle as the residual vector between the motion information and the motion information of the target obstacle in the last cycle. For example, if the speed information of the target obstacle corresponding to the observed center displacement amount, the observed gravity center displacement amount, the observed edge center displacement amount and the observed corner displacement amount determined in the step 203 is respectively: 10 m/s, 12 m/s, 13 m/s and 15 m/s, and the speed information of the target obstacle generated in the laser point cloud frame immediately prior to the current laser point cloud frame collected by the laser point is 9 m/s, i.e., the speed information obtained through motion estimation of the target obstacle in the last cycle is 9 m/s, then here, 10 m/s, which is closest to the speed information obtained through motion estimation of the target obstacle in the last period (9 m/s), is selected from the four types of speed information: 10 m/s, 12 m/s, 13 m/s and 15 m/s as the observed speed information of the target obstacle in accordance with a kinematic rule. Then, if the sampling period of the lidar is 0.1 s, the observed acceleration information of the target obstacle may be determined as 10 m/s² based on the determined observed speed information of 10 m/s.

In some optional implementations of the embodiment, the electronic device may also determine the observed motion information of the target obstacle in accordance with a statistical rule based on the M types of motion information determined in the step 203 and the historical motion information of the target obstacle.

As an example, the electronic device may determine average value information of the determined M types of motion information as the observed motion information of the target obstacle.

As an example, the electronic device may further rank the determined M types of motion information, fraction the M types of motion information by a preset fractile (e.g., decile) based on the ranking result, generate a preset fractile number of fractile results, and then determine the fractile results of a preset fractile (e.g., 90%) as the observed motion information of the target obstacle.

As an example, the electronic device may further first calculate average motion information of the determined M types of motion information, then select the motion information having a minimum modulus of a vector difference between the motion information and the average motion information obtained through calculation from the determined M types of motion information, and then determine the selected motion information as the observed motion information of the target obstacle. Of course, the electronic device may further first remove noise from the determined M types of motion information according to a statistic rule, and then determine the observed motion information of the target obstacle in accordance with the three illustrated implementations based on the motion information obtained after removing noise.

Step 205: generating current motion information of the target obstacle using a preset filtering algorithm with the motion information of the target obstacle as a state variable, and the observed motion information as an observed amount.

In the embodiment, the electronic device may generate current motion information of the target obstacle using a preset filtering algorithm with the motion information of the target obstacle as a state variable, and the observed motion information of the target obstacle determined in the step 204 as an observed amount after determining the observed motion information of the target obstacle in the step 204. Thus, the observed motion information of the target obstacle may be smoothed to obtain more accurate current motion information of the target obstacle. Here, the filtering algorithm may be any filtering algorithm, and is not specifically limited in the disclosure.

In some optional implementations of the embodiment, the filtering algorithm may be Kalman Filter, Extended Kalman Filter, Unscented Kalman Filter, or Gaussian Filter.

Here, the filtering operation in the step 205 may be executed by the electronic device, or the electronic device transmits the observed motion information of the target obstacle to a filter with a filtering function as an observed amount. The filter implements a filtering operation, and then returns the result to the electronic device.

In some optional implementations of the embodiment, the step 205 may be implemented as follows:

First, a filtering parameter in the preset filtering algorithm is adjusted based on a similarity between the obstacle point cloud in the current frame and the obstacle point cloud in the reference frame.

Here, the electronic device correlates the obstacle point cloud in the current frame with the obstacle point cloud in the reference frame to obtain an obstacle point cloud characterizing a given obstacle, i.e., the target obstacle. If the similarity between them is greater than a preset similarity threshold (e.g., 0.9), it indicates that both are very likely to characterize the given obstacle, and then, the observed motion information of the target obstacle obtained from the step 202 to the step 204 based on the obstacle point cloud in the current frame and the obstacle point cloud in the reference frame has a high confidence level. Therefore, a filtering parameter in the preset filtering algorithm may be adjusted to enhance the confidence level of the observed motion information as an observed amount in the filtering algorithm. For example, relevant parameters of the measurement noise may be modified to properly reduce the confidence level of the measurement noise in the preset filtering algorithm, thereby enhancing the confidence level of the observed motion information as an observed amount in the preset filtering algorithm. Otherwise, if the similarity between them is less than or equal to the preset similarity threshold (e.g., 0.9), it indicates that both are less likely to characterize a given obstacle, and then, the observed motion information of the target obstacle obtained from the step 202 to the step 204 based on the obstacle point cloud in the current frame and the obstacle point cloud in the reference frame has a low confidence level. Therefore, a filtering parameter in the preset filtering algorithm may be adjusted to reduce the confidence level of the observed motion information as an observed amount in the filtering algorithm. For example, relevant parameters of the measurement noise may be modified to properly enhance the confidence level of the measurement noise in the preset filtering algorithm, thereby reducing the confidence level of the observed motion information as an observed amount in the preset filtering algorithm.

It should be noted that when a filtering parameter in the preset filtering algorithm is adjusted based on the similarity between the obstacle point cloud in the current frame and the obstacle point cloud in the reference frame, the to-be-adjusted parameter and the adjustment of the parameter by increase or decrease are associated with a specific filtering algorithm due to the difference between filtering algorithms. The specific adjustment method is known to those skilled in the art, and is not repeated any more here.

Then current motion information of the target obstacle is generated using the preset filtering algorithm with the adjusted filtering parameter with the motion information of the target obstacle as a state variable, and the observed motion information as an observed amount.

Here, because a filtering parameter in the preset filtering algorithm is adjusted based on the similarity between the obstacle point cloud in the current frame and the obstacle point cloud in the reference frame, the adjusted preset filtering algorithm may improve the accuracy of the motion information of the target obstacle obtained through calculation by self-adaption based on the similarity between the obstacle point cloud in the current frame and the obstacle point cloud in the reference frame.

After the electronic device generates the current motion information of the target obstacle in the step 205, motion estimation of the target obstacle is realized, so that the electronic device may track the target obstacle based on the motion estimation of the target obstacle, i.e., generate a motion trail of the target obstacle.

A method provided by an embodiment of the disclosure acquires an obstacle point cloud in a current frame and the obstacle point cloud in a reference frame characterizing a target obstacle with to-be-generated motion information, where the obstacle point cloud in the current frame is obtained based on a current laser point cloud frame collected by the lidar, and the obstacle point cloud in the reference frame is obtained based on a laser point cloud characterizing the target obstacle in a preset number of laser point cloud frames prior to the current laser point cloud frame collected by the lidar; calculates a first observed displacement of the target obstacle corresponding to a first observed displacement amount in each of M first observed displacement amounts based on the obstacle point cloud in the current frame and the obstacle point cloud in the reference frame; determines motion information of the target obstacle corresponding to the first observed displacement amount in the each of the M first observed displacement amounts based on M first observed displacements obtained through calculation and the sampling period of the lidar; then determines observed motion information of the target obstacle in accordance with a kinematic rule or a statistical rule based on the determined M types of motion information and historical motion information of the target obstacle; and finally generates current motion information of the target obstacle using a preset filtering algorithm with the motion information of the target obstacle as a state variable, and the observed motion information as an observed amount. Therefore, effective motion estimation of the obstacle may still be achieved even when a point cloud of the obstacle is inaccurately segmented.

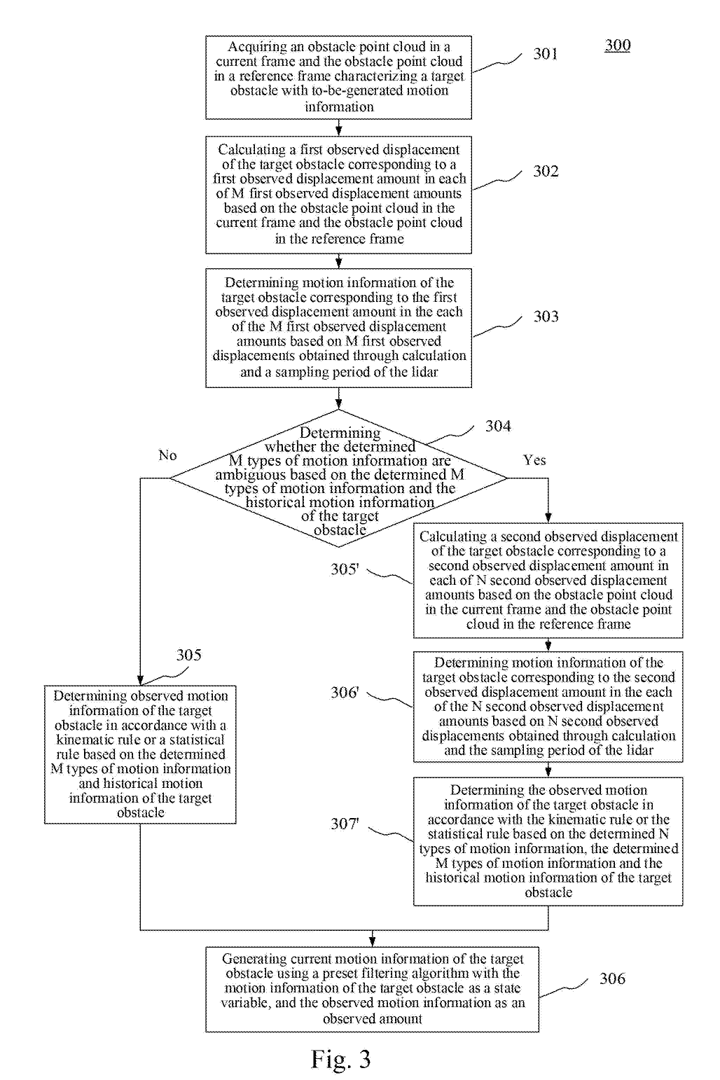

By further referring to FIG. 3, a process 300 of another embodiment of a method for generating obstacle motion information for an autonomous vehicle according to the disclosure is shown, and the process 300 of the method for generating obstacle motion information for an autonomous vehicle includes:

Step 301: acquiring an obstacle point cloud in a current frame and the obstacle point cloud in a reference frame characterizing a target obstacle with to-be-generated motion information.

Step 302: calculating a first observed displacement of the target obstacle corresponding to a first observed displacement amount in each of M first observed displacement amounts based on the obstacle point cloud in the current frame and the obstacle point cloud in the reference frame.

Step 303: determining motion information of the target obstacle corresponding to the first observed displacement amount in the each of the M first observed displacement amounts based on M first observed displacements obtained through calculation and a sampling period of the lidar.

Specific operations in the steps 301, 302 and 303 in the embodiment are basically identical to those in the steps 201, 202 and 203 in the embodiment shown in FIG. 2, and are not repeated any more here.

Step 304: determining whether the determined M types of motion information are ambiguous based on the determined M types of motion information and the historical motion information of the target obstacle.

In the embodiment, an electronic device (for example, the driving control device as shown in FIG. 1) on which the method for generating obstacle motion information for an autonomous vehicle runs may determine whether the determined M types of motion information are ambiguous using a variety of implementations based on the determined M types of motion information and the historical motion information of the target obstacle, after determining the motion information of the target obstacle corresponding to the first observed displacement amount in the each of the M first observed displacement amounts in the step 303. Here, the M types of motion information being ambiguous means that the motion state of the target obstacle cannot be determined based on the M types of motion information. For example, one type of information in the M types of motion information indicates that the target obstacle is running at an accelerated speed, while the other type of motion information shows that the target obstacle is running at a decelerated speed. The two types of motion information are contradictory, and then, whether the target obstacle is accelerating or decelerating cannot be determined, i.e., the M types of motion information are ambiguous.

Each of the M types of motion information determined in the step 303 is information characterizing the motion state of the target obstacle. If the M types of motion information determined in the step 303 are ambiguous, it indicates that the observed motion information of the target obstacle cannot be determined based on the M types of motion information determined in the step 303, and then step 305′ may be executed. If the M types of motion information determined in the step 303 are not ambiguous, it indicates that the observed motion information of the target obstacle may be determined based on the M types of motion information determined in the step 303, and then step 305 may be executed.

In some optional implementations of the embodiment, the step 304 may be implemented as follows:

First, for each type of motion information in the determined M types of motion information, a residual vector between the motion information and motion information of the target obstacle in the last cycle is determined.

Here, the motion information of the target obstacle in the last cycle is the motion information of the target obstacle generated by the electronic device from the laser point cloud frame immediately prior to the current laser point cloud frame collected by the lidar, i.e., the motion information obtained through motion estimation of motion information of the target obstacle in the last cycle (i.e., a sampling period of the lidar).

In some implementations, the electronic device may determine, for each type of motion information in the determined M types of motion information, a differential vector between the motion information and the motion information of the target obstacle in the last cycle as the residual vector between the motion information and the motion information of the target obstacle in the last cycle.

In some implementations, the electronic device may also execute for each type of motion information in the determined M types of motion information: first generating estimated motion information of the target obstacle using the preset filtering algorithm with the motion information of the target obstacle as a state variable, and the motion information as an observed amount; and then determining a differential vector between the generated estimated motion information and the motion information of the target obstacle in the last cycle as the residual vector between the motion information and the motion information of the target obstacle in the last cycle.

Secondly, a residual vector with a minimum modulus in the M residual vectors obtained through calculation is determined as a first minimum residual vector.

Thirdly, the determined M types of motion information being not ambiguous is determined in response to the modulus of the first minimum residual vector being less than a first preset modulus threshold.

Fourthly, the determined M types of motion information being ambiguous is determined in response to the modulus of the first minimum residual vector being greater than or equal to the first preset modulus threshold.

In some optional implementations of the embodiment, the step 304 may also be implemented as follows:

First, for each type of motion information in the determined M types of motion information, a residual vector between the motion information and motion information of the target obstacle in the last cycle is determined.

Here, the determining, for each type of motion information in the determined M types of motion information, a residual vector between the motion information and the motion information of the target obstacle in the last cycle may be implemented using a method similar to what is described in the optional implementations of the step 304.

Secondly, an average vector of the determined M residual vectors is calculated.

Thirdly, a residual vector with a minimum modulus of a vector difference from the average vector obtained through calculation in the determined M residual vectors is determined as a second minimum residual vector.

Fourthly, the determined M types of motion information being not ambiguous is determined in response to the modulus of the second minimum residual vector being less than a second preset modulus threshold.

Fifthly, the determined M types of motion information being ambiguous is determined in response to the modulus of the second minimum residual vector being greater than or equal to the second preset modulus threshold.

Step 305: determining observed motion information of the target obstacle in accordance with a kinematic rule or a statistical rule based on the determined M types of motion information and historical motion information of the target obstacle.

In the embodiment, an electronic device (for example, the driving control device as shown in FIG. 1) on which the method for generating obstacle motion information for an autonomous vehicle runs may determine observed motion information of the target obstacle in accordance with a kinematic rule or a statistical rule based on the determined M types of motion information and historical motion information of the target obstacle when the determined M types of motion information are not ambiguous, as determined in the step 304, and then go to step 306 after the execution of the step 305.

Here, specific operations in the step 305 are basically identical to those in the step 204 in the embodiment shown in FIG. 2, and are not repeated any more here.

Step 305′: calculating a second observed displacement of the target obstacle corresponding to a second observed displacement amount in each of N second observed displacement amounts based on the obstacle point cloud in the current frame and the obstacle point cloud in the reference frame.

In the embodiment, when the determined M types of motion information are ambiguous, as determined in the step 304, i.e., motion estimation of the target obstacle cannot be implemented based on the determined M types of motion information, an electronic device (for example, the driving control device as shown in FIG. 1) on which the method for generating obstacle motion information for an autonomous vehicle runs may calculate a second observed displacement of the target obstacle corresponding to a second observed displacement amount in each of N second observed displacement amounts based on the obstacle point cloud in the current frame and the obstacle point cloud in the reference frame, to realize motion estimation of the target obstacle. Here, the calculation amount of the second observed displacement amount in the each of the N second observed displacement amounts is greater than the calculation amount of the first observed displacement amount in the each of the M first observed displacement amounts. Step 306′ is executed after the execution of the step 305′. That is, motion estimation of the target obstacle cannot be implemented based on the M types of motion information when the M types of motion information determined based on the first observed displacement in the each of the M first observed displacement amounts with small calculation amounts are ambiguous. Under the circumstance, the second observed displacement amount with a large calculation amount may be used for implementing motion estimation of the target obstacle.

In some optional implementations of the embodiment, the second observed displacement amount may include an observed surface displacement amount.

As an example, the calculating a second observed displacement of the target obstacle corresponding to an observed surface displacement amount based on the obstacle point cloud in the current frame and the obstacle point cloud in the reference frame may include:

First, the coordinates of at least one surface point of the obstacle point cloud in the current frame and the coordinates of the at least one surface point of the obstacle point cloud in the reference frame are acquired. Here, the coordinate of the surface point of an obstacle point cloud is the coordinate of a point on the surface of the obstacle characterized by the obstacle point cloud, and are determined using an existing technology that is widely researched and applied at present, and is not repeated any more here.

Then, the minimum distance among the distances between each of the coordinates of at least one surface point of the obstacle point cloud in the current frame and each of the coordinates of the corresponding surface points of the obstacle point cloud in the reference frame is determined as the surface point displacement of the coordinate of the surface point relative to the obstacle point cloud in the reference frame.

Finally, an average displacement of the surface point displacements of each of the coordinates of the at least one surface point of the obstacle point cloud in the current frame relative to the obstacle point cloud in the reference frame is determined as a second observed displacement of the target obstacle corresponding to an observed surface displacement amount of the point cloud.

As an example, the second observed displacement of the target obstacle corresponding to the observed surface displacement amount may also be calculated based on the obstacle point cloud in the current frame and the obstacle point cloud in the reference frame by calculating a displacement between surfaces using ICP (Iterative Closest Point) algorithm.

Step 306′: determining motion information of the target obstacle corresponding to the second observed displacement amount in the each of the N second observed displacement amounts based on N second observed displacements obtained through calculation and the sampling period of the lidar.

Here, specific operations in the step 306′ may be referred to in relevant description of the step 203 in the embodiment shown in FIG. 2, and are not repeated any more here.

Here, step 307′ may be executed after the execution of the step 306′.

Step 307′: determining the observed motion information of the target obstacle in accordance with the kinematic rule or the statistical rule based on the determined N types of motion information, the determined M types of motion information and the historical motion information of the target obstacle.

Here, specific operations in the step 307′ may be referred to in relevant description of the step 204 in the embodiment shown in FIG. 2, and are not repeated any more here.

Here, step 306 may be executed after the execution of the step 307′.

Step 306: generating current motion information of the target obstacle using a preset filtering algorithm with the motion information of the target obstacle as a state variable, and the observed motion information as an observed amount.

Here, specific operations in the step 306 are basically identical to those in the step 205 in the embodiment shown in FIG. 2, and are not repeated any more here.

In some optional implementations of the embodiment, the electronic device may further execute before the step 306:

First, whether the modulus of a residual vector between the observed motion information and the motion information of the target obstacle in the last cycle is greater than a third preset modulus threshold may be determined.

That is, whether there is a great deviation between the observed motion information and the motion information of the target obstacle in the last cycle is determined.

Secondly, the observed motion information is updated using motion information obtained through multiplying the observed motion information by a first ratio in response to determining the modulus of the residual vector between the observed motion information and the motion information of the target obstacle in the last cycle being greater than the third preset modulus threshold.

Here, the first ratio is obtained through dividing the third preset modulus threshold by the modulus of the residual vector between the observed motion information and the motion information of the target obstacle in the last cycle.

By the updating the observed motion information, the modulus of the residual vector between the updated observed motion information and the motion information of the target obstacle in the last cycle is less than or equal to the third preset modulus threshold, to correct the observed motion information, and realize more accurate motion estimation during motion estimation of the target obstacle based on the updated observed motion information.

As can be seen from FIG. 3, compared to the embodiment corresponding to FIG. 2, the process 300 of a method for generating obstacle motion information for an autonomous vehicle according to the embodiment additionally includes performing motion estimation of the target obstacle based on N second observed displacement amounts with large calculation amounts when the M types of motion information are ambiguous. Therefore, the solution described in the embodiment may implement more comprehensive obstacle motion estimation.

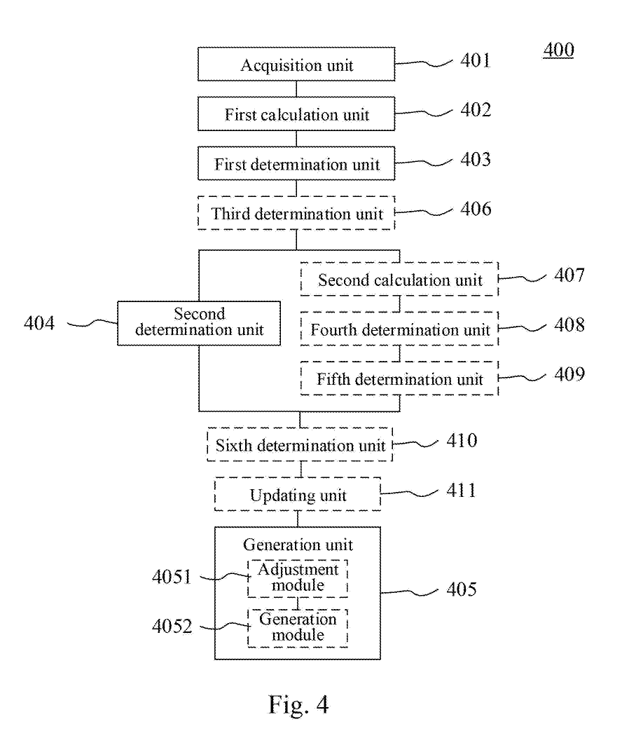

By further referring to FIG. 4, as implementations of the methods shown in the figures, the disclosure provides an embodiment of an apparatus for generating obstacle motion information for an autonomous vehicle. The embodiment of the apparatus corresponds to the embodiment of the method shown in FIG. 2, and the apparatus may be applied to a variety of electronic devices.

As shown in FIG. 4, an apparatus 400 for generating obstacle motion information for an autonomous vehicle according to the embodiment includes: an acquisition unit 401, a first calculation unit 402, a first determination unit 403, a second determination unit 404, and a generation unit 405. Here, the acquisition unit 401 is configured for acquiring an obstacle point cloud in a current frame and the obstacle point cloud in a reference frame characterizing a target obstacle with to-be-generated motion information, where the obstacle point cloud in the current frame is obtained based on a current laser point cloud frame collected by the lidar, and the obstacle point cloud in the reference frame is obtained based on a laser point cloud characterizing the target obstacle in a preset number of laser point cloud frames prior to the current laser point cloud frame collected by the lidar; the first calculation unit 402 is configured for calculating a first observed displacement of the target obstacle corresponding to a first observed displacement amount in each of M first observed displacement amounts based on the obstacle point cloud in the current frame and the obstacle point cloud in the reference frame; the first determination unit 403 is configured for determining motion information of the target obstacle corresponding to the first observed displacement amount in the each of the M first observed displacement amounts based on M first observed displacements obtained through calculation and the sampling period of the lidar; the second determination unit 404 is configured for determining observed motion information of the target obstacle in accordance with a kinematic rule or a statistical rule based on the determined M types of motion information and historical motion information of the target obstacle; and the generation unit 405 is configured for generating current motion information of the target obstacle using a preset filtering algorithm with the motion information of the target obstacle as a state variable, and the observed motion information as an observed amount.

Specific processing of the acquisition unit 401, the first calculation unit 402, the first determination unit 403, the second determination unit 404 and the generation unit 405 of the apparatus 400 for generating obstacle motion information for an autonomous vehicle according to the embodiment and the technical effects brought thereby may be respectively referred to in relevant description of the steps 201, 202, 203, 204 and 205 in the embodiment corresponding to FIG. 2, and are not repeated any more here.

In some optional implementations of the embodiment, the apparatus 400 may further include: a third determination unit 406 configured for determining whether the determined M types of motion information are ambiguous based on the determined M types of motion information and the historical motion information of the target obstacle; and the second determination unit 404 may be further configured for: determining the observed motion information of the target obstacle in accordance with the kinematic rule or the statistical rule based on the determined M types of motion information and the historical motion information of the target obstacle in response to determining the determined M types of motion information being not ambiguous.

In some optional implementations of the embodiment, the third determination unit 406 may be further configured for: determining, for each type of motion information in the determined M types of motion information, a residual vector between the motion information and motion information of the target obstacle in the last cycle; determining a residual vector with a minimum modulus in the M residual vectors obtained through calculation as a first minimum residual vector; determining the determined M types of motion information being not ambiguous in response to the modulus of the first minimum residual vector being less than a first preset modulus threshold; and determining the determined M types of motion information being ambiguous in response to the modulus of the first minimum residual vector being greater than or equal to the first preset modulus threshold.

In some optional implementations of the embodiment, the third determination unit 406 may be further configured for: determining, for each type of motion information in the determined M types of motion information, a residual vector between the motion information and motion information of the target obstacle in the last cycle; calculating an average vector of the determined M residual vectors; determining a residual vector with a minimum modulus of a vector difference from the average vector obtained through calculation in the determined M residual vectors as a second minimum residual vector; determining the determined M types of motion information being not ambiguous in response to the modulus of the second minimum residual vector being less than a second preset modulus threshold; and determining the determined M types of motion information being ambiguous in response to the modulus of the second minimum residual vector being greater than or equal to the second preset modulus threshold.

In some optional implementations of the embodiment, the third determination unit 406 may be further configured for: determining, for each type of motion information in the determined M types of motion information, a differential vector between the motion information and the motion information of the target obstacle in the last cycle as the residual vector between the motion information and the motion information of the target obstacle in the last cycle.

In some optional implementations of the embodiment, the third determination unit 406 may be further configured for: executing for each type of motion information in the determined M types of motion information: generating estimated motion information of the target obstacle using the preset filtering algorithm with the motion information of the target obstacle as a state variable, and the motion information as an observed amount; and determining a differential vector between the generated estimated motion information and the motion information of the target obstacle in the last cycle as the residual vector between the motion information and the motion information of the target obstacle in the last cycle.

In some optional implementations of the embodiment, the apparatus 400 may further include: a second calculation unit 407 configured for calculating a second observed displacement of the target obstacle corresponding to a second observed displacement amount in each of N second observed displacement amounts based on the obstacle point cloud in the current frame and the obstacle point cloud in the reference frame in response to determining the determined M types of motion information being ambiguous, where the calculation amount of the second observed displacement amount in the each of the N second observed displacement amounts is greater than the calculation amount of the first observed displacement amount in the each of the M first observed displacement amounts; a fourth determination unit 408 configured for determining motion information of the target obstacle corresponding to the second observed displacement amount in the each of the N second observed displacement amounts based on N second observed displacements obtained through calculation and the sampling period of the lidar; and a fifth determination unit 409 configured for determining the observed motion information of the target obstacle in accordance with the kinematic rule or the statistical rule based on the determined N types of motion information, the determined M types of motion information and the historical motion information of the target obstacle.

In some optional implementations of the embodiment, the apparatus 400 may further include a sixth determination unit 410 configured for determining whether the modulus of a residual vector between the observed motion information and the motion information of the target obstacle in the last cycle is greater than a third preset modulus threshold; and an updating unit 411 configured for updating the observed motion information using motion information obtained through multiplying the observed motion information by a first ratio in response to determining the modulus of a residual vector between the observed motion information and the motion information of the target obstacle in the last cycle being greater than the third preset modulus threshold, where the first ratio is obtained through dividing the third preset modulus threshold by the modulus of the residual vector between the observed motion information and the motion information of the target obstacle in the last cycle.

In some optional implementations of the embodiment, the generation unit 405 may include: an adjustment module 4051 configured for adjusting a filtering parameter in the preset filtering algorithm based on a similarity between the obstacle point cloud in the current frame and the obstacle point cloud in the reference frame; and a generation module 4052 configured for generating current motion information of the target obstacle using the preset filtering algorithm with the adjusted filtering parameter with the motion information of the target obstacle as a state variable, and the observed motion information as an observed amount.

In some optional implementations of the embodiment, the motion information may include at least one of: speed information, or acceleration information.

In some optional implementations of the embodiment, the M first observed displacement amounts may include at least one of: an observed center displacement amount, an observed gravity center displacement amount, an observed edge center displacement amount, or an observed corner displacement amount.

In some optional implementations of the embodiment, the N second observed displacement amount may include an observed surface displacement amount.

It should be noted that implementation details and technical effects of the units in the apparatus for generating obstacle motion information for an autonomous vehicle according to the embodiment of the disclosure may be referred to in relevant description of the embodiment shown in FIG. 2, and are not repeated any more here.

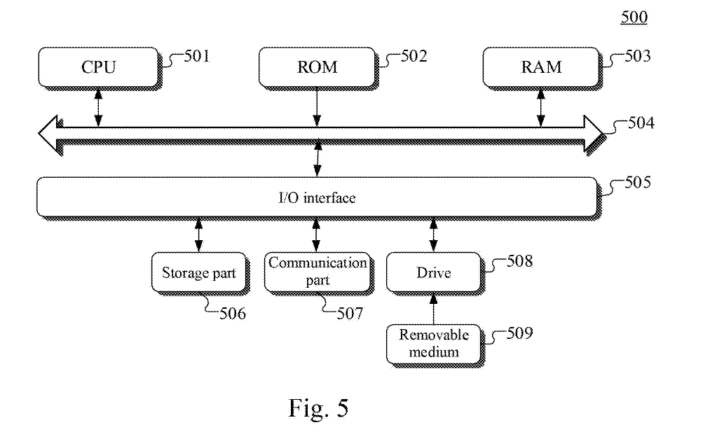

Referring to FIG. 5, a schematic structural diagram of a computer system 500 adapted to implement the driving control device of the embodiments of the present application is shown. The driving control device shown in FIG. 5 is merely an example and should not impose any restriction on the function and scope of use of the embodiments of the present application.

As shown in FIG. 5, the computer system 500 includes a central processing unit (CPU) 501, which may execute various appropriate actions and processes in accordance with a program stored in a read-only memory (ROM) 502 or a program loaded into a random access memory (RAM) 503 from a storage portion 508. The RAM 503 also stores various programs and data required by operations of the system 500. The CPU 501, the ROM 502 and the RAM 503 are connected to each other through a bus 504. An input/output (I/O) interface 505 is also connected to the bus 504.

The following components are connected to the I/O interface 505: a storage portion 506 including a hard disk and the like; and a communication portion 507 comprising a network interface card, such as a LAN card and a modem. The communication portion 507 performs communication processes via a network, such as the Internet. A drive 508 is also connected to the I/O interface 505 as required. A removable medium 509, such as a magnetic disk, an optical disk, a magneto-optical disk, and a semiconductor memory, may be installed on the drive 508, to facilitate the retrieval of a computer program from the removable medium 509, and the installation thereof on the storage portion 506 as needed.

In particular, according to embodiments of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method as illustrated in the flow chart. In such an embodiment, the computer program may be downloaded and installed from a network via the communication portion 507, and/or may be installed from the removable media 509. The computer program, when executed by the central processing unit (CPU) 501, implements the above mentioned functionalities as defined by the methods of the present disclosure. It should be noted that the computer readable medium in the present disclosure may be computer readable storage medium. An example of the computer readable storage medium may include, but not limited to: semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. The computer readable medium may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units or modules involved in the embodiments of the present application may be implemented by means of software or hardware. The described units or modules may also be provided in a processor, for example, described as: a processor, comprising an acquisition unit, a first calculation unit, a first determination unit, a second determination unit, and a generation unit, where the names of these units or modules do not in some cases constitute a limitation to such units or modules themselves. For example, the generation unit may also be described as “a unit for generating current motion information of the target obstacle.”

In another aspect, the present application further provides a non-transitory computer-readable storage medium. The non-transitory computer-readable storage medium may be the non-transitory computer-readable storage medium included in the apparatus in the above described embodiments, or a stand-alone non-transitory computer-readable storage medium not assembled into the apparatus. The non-transitory computer-readable storage medium stores one or more programs. The one or more programs, when executed by a device, cause the device to: acquire an obstacle point cloud in a current frame and the obstacle point cloud of in a reference frame characterizing a target obstacle with to-be-generated motion information, wherein the obstacle point cloud in the current frame is obtained based on a current laser point cloud frame collected by the lidar, and the obstacle point cloud in the reference frame is obtained based on a laser point cloud characterizing the target obstacle in a preset number of laser point cloud frames prior to the current laser point cloud frame collected by the lidar; calculate a first observed displacement of the target obstacle corresponding to a first observed displacement amount in each of M first observed displacement amounts based on the obstacle point cloud in the current frame and the obstacle point cloud in the reference frame; determine motion information of the target obstacle corresponding to the first observed displacement amount in the each of the M first observed displacement amounts based on M first observed displacements obtained through calculation and a sampling period of the lidar; determine observed motion information of the target obstacle in accordance with a kinematic rule or a statistical rule based on the determined M types of motion information and historical motion information of the target obstacle; and generate current motion information of the target obstacle using a preset filtering algorithm with the motion information of the target obstacle as a state variable, and the observed motion information as an observed amount.

The above description only provides an explanation of the preferred embodiments of the present application and the technical principles used. It should be appreciated by those skilled in the art that the inventive scope of the present application is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present application are examples.

What is claimed is:

1. A method for generating obstacle motion information for an autonomous vehicle, the autonomous vehicle equipped with a lidar, and the method comprising:
acquiring an obstacle point cloud in a current frame and the obstacle point cloud in a reference frame characterizing a target obstacle with to-be-generated motion information, wherein the obstacle point cloud in the current frame is obtained based on a current laser point cloud frame collected by the lidar, and the obstacle point cloud in the reference frame is obtained based on a laser point cloud characterizing the target obstacle in a preset number of laser point cloud frames prior to the current laser point cloud frame collected by the lidar;
calculating a first observed displacement of the target obstacle corresponding to a first observed displacement amount in each of M first observed displacement amounts based on the obstacle point cloud in the current frame and the obstacle point cloud in the reference frame;
determining motion information of the target obstacle corresponding to the first observed displacement amount in the each of the M first observed displacement amounts based on M first observed displacements obtained through calculation and a sampling period of the lidar;
determining observed motion information of the target obstacle in accordance with a kinematic rule or a statistical rule based on the determined M types of motion information and historical motion information of the target obstacle; and
generating current motion information of the target obstacle using a preset filtering algorithm with the motion information of the target obstacle as a state variable, and the observed motion information as an observed amount.

2. The method according to claim 1, wherein before the determining observed motion information of the target obstacle in accordance with a kinematic rule or a statistical rule based on the determined M types of motion information and historical motion information of the target obstacle, the method further comprises:
determining whether the determined M types of motion information are ambiguous based on the determined M types of motion information and the historical motion information of the target obstacle; and
the determining observed motion information of the target obstacle in accordance with a kinematic rule or a statistical rule based on the determined M types of motion information and historical motion information of the target obstacle comprises:
determining the observed motion information of the target obstacle in accordance with the kinematic rule or the statistical rule based on the determined M types of motion information and the historical motion information of the target obstacle in response to determining the determined M types of motion information being not ambiguous.

3. The method according to claim 2, wherein the determining whether the determined M types of motion information are ambiguous based on the determined M types of motion information and the historical motion information of the target obstacle comprises:
determining, for each type of motion information in the determined M types of motion information, a residual vector between the motion information and motion information of the target obstacle in a last cycle;
determining a residual vector with a minimum modulus in the M residual vectors obtained through calculation as a first minimum residual vector;
determining the determined M types of motion information being not ambiguous in response to the modulus of the first minimum residual vector being less than a first preset modulus threshold; and
determining the determined M types of motion information being ambiguous in response to the modulus of the first minimum residual vector being greater than or equal to the first preset modulus threshold.

4. The method according to claim 2, wherein the determining whether the determined M types of motion information are ambiguous based on the determined M types of motion information and the historical motion information of the target obstacle comprises:
determining, for each type of motion information in the determined M types of motion information, a residual vector between the motion information and motion information of the target obstacle in a last cycle;
calculating an average vector of the determined M residual vectors;
determining a residual vector with a minimum modulus of a vector difference from the average vector obtained through calculation in the determined M residual vectors as a second minimum residual vector;
determining the determined M types of motion information being not ambiguous in response to the modulus of the second minimum residual vector being less than a second preset modulus threshold; and
determining the determined M types of motion information being ambiguous in response to the modulus of the second minimum residual vector being greater than or equal to the second preset modulus threshold.

5. The method according to claim 3, wherein the determining, for each type of motion information in the determined M types of motion information, a residual vector between the motion information and motion information of the target obstacle in a last cycle comprises:
determining, for each type of motion information in the determined M types of motion information, a differential vector between the motion information and the motion information of the target obstacle in the last cycle as the residual vector between the motion information and the motion information of the target obstacle in the last cycle.

6. The method according to claim 3, wherein the determining, for each type of motion information in the determined M types of motion information, a residual vector between the motion information and motion information of the target obstacle in a last cycle comprises:
executing for each type of motion information in the determined M types of motion information: generating estimated motion information of the target obstacle using the preset filtering algorithm with the motion information of the target obstacle as a state variable, and the motion information as an observed amount; and determining a differential vector between the generated estimated motion information and the motion information of the target obstacle in the last cycle as the residual vector between the motion information and the motion information of the target obstacle in the last cycle.

7. The method according to claim 2, further comprising:
calculating a second observed displacement of the target obstacle corresponding to a second observed displacement amount in each of N second observed displacement amounts based on the obstacle point cloud in the current frame and the obstacle point cloud in the reference frame in response to determining the determined M types of motion information being ambiguous, wherein the calculation amount of the second observed displacement amount in the each of the N second observed displacement amounts is greater than the calculation amount of the first observed displacement amount in the each of the M first observed displacement amounts;
determining motion information of the target obstacle corresponding to the second observed displacement amount in the each of the N second observed displacement amounts based on N second observed displacements obtained through calculation and the sampling period of the lidar; and
determining the observed motion information of the target obstacle in accordance with the kinematic rule or the statistical rule based on the determined N types of motion information, the determined M types of motion information and the historical motion information of the target obstacle.

8. The method according to claim 7, wherein before the generating current motion information of the target obstacle using a preset filtering algorithm with the motion information of the target obstacle as a state variable, and the observed motion information as an observed amount, the method further comprises:
determining whether the modulus of a residual vector between the observed motion information and the motion information of the target obstacle in the last cycle is greater than a third preset modulus threshold; and
updating the observed motion information using motion information obtained through multiplying the observed motion information by a first ratio in response to determining the modulus of the residual vector between the observed motion information and the motion information of the target obstacle in the last cycle being greater than the third preset modulus threshold, wherein the first ratio is obtained through dividing the third preset modulus threshold by the modulus of the residual vector between the observed motion information and the motion information of the target obstacle in the last cycle.

9. The method according to claim 8, wherein the generating current motion information of the target obstacle using a preset filtering algorithm with the motion information of the target obstacle as a state variable, and the observed motion information as an observed amount comprises:
adjusting a filtering parameter in the preset filtering algorithm based on a similarity between the obstacle point cloud in the current frame and the obstacle point cloud in the reference frame; and
generating current motion information of the target obstacle using the preset filtering algorithm with the adjusted filtering parameter with the motion information of the target obstacle as a state variable, and the observed motion information as an observed amount.

10. The method according to claim 9, wherein the motion information comprises at least one of: speed information, or acceleration information.

11. The method according to claim 10, wherein the M first observed displacement amounts comprise at least one of: an observed center displacement amount, an observed gravity center displacement amount, an observed edge center displacement amount, or an observed corner displacement amount.

12. The method according to claim 11, wherein the N second observed displacement amounts comprise an observed surface displacement amount.

13. An apparatus for generating obstacle motion information for an autonomous vehicle, the autonomous vehicle equipped with a lidar, and the apparatus comprising:
at least one processor; and
a memory storing instructions, the instructions when executed by the at least one processor, cause the at least one processor to perform operations, the operations comprising:
acquiring an obstacle point cloud in a current frame and the obstacle point cloud in a reference frame characterizing a target obstacle with to-be-generated motion information, wherein the obstacle point cloud in the current frame is obtained based on a current laser point cloud frame collected by the lidar, and the obstacle point cloud in the reference frame is obtained based on a laser point cloud characterizing the target obstacle in a preset number of laser point cloud frames prior to the current laser point cloud frame collected by the lidar;
calculating a first observed displacement of the target obstacle corresponding to a first observed displacement amount in each of M first observed displacement amounts based on the obstacle point cloud in the current frame and the obstacle point cloud in the reference frame;
determining motion information of the target obstacle corresponding to the first observed displacement amount in the each of the M first observed displacement amounts based on M first observed displacements obtained through calculation and a sampling period of the lidar;
determining observed motion information of the target obstacle in accordance with a kinematic rule or a statistical rule based on the determined M types of motion information and historical motion information of the target obstacle; and
generating current motion information of the target obstacle using a preset filtering algorithm with the motion information of the target obstacle as a state variable, and the observed motion information as an observed amount.

14. The apparatus according to claim 13, wherein before the determining observed motion information of the target obstacle in accordance with a kinematic rule or a statistical rule based on the determined M types of motion information and historical motion information of the target obstacle, the operations further comprise:
determining whether the determined M types of motion information are ambiguous based on the determined M types of motion information and the historical motion information of the target obstacle; and
the determining observed motion information of the target obstacle in accordance with a kinematic rule or a statistical rule based on the determined M types of motion information and historical motion information of the target obstacle comprises:
determining the observed motion information of the target obstacle in accordance with the kinematic rule or the statistical rule based on the determined M types of motion information and the historical motion information of the target obstacle in response to determining the determined M types of motion information being not ambiguous.

15. The apparatus according to claim 14, wherein the determining whether the determined M types of motion information are ambiguous based on the determined M types of motion information and the historical motion information of the target obstacle comprises:
determining, for each type of motion information in the determined M types of motion information, a residual vector between the motion information and motion information of the target obstacle in a last cycle;
determining a residual vector with a minimum modulus in the M residual vectors obtained through calculation as a first minimum residual vector;
determining the determined M types of motion information being not ambiguous in response to the modulus of the first minimum residual vector being less than a first preset modulus threshold; and
determining the determined M types of motion information being ambiguous in response to the modulus of the first minimum residual vector being greater than or equal to the first preset modulus threshold.

16. The apparatus according to claim 14, wherein the determining whether the determined M types of motion information are ambiguous based on the determined M types of motion information and the historical motion information of the target obstacle comprises:
determining, for each type of motion information in the determined M types of motion information, a residual vector between the motion information and motion information of the target obstacle in a last cycle;
calculating an average vector of the determined M residual vectors;
determining a residual vector with a minimum modulus of a vector difference from the average vector obtained through calculation in the determined M residual vectors as a second minimum residual vector;
determining the determined M types of motion information being not ambiguous in response to the modulus of the second minimum residual vector being less than a second preset modulus threshold; and
determining the determined M types of motion information being ambiguous in response to the modulus of the second minimum residual vector being greater than or equal to the second preset modulus threshold.

17. The apparatus according to claim 15, wherein the determining, for each type of motion information in the determined M types of motion information, a residual vector between the motion information and motion information of the target obstacle in a last cycle comprises:
determining, for each type of motion information in the determined M types of motion information, a differential vector between the motion information and the motion information of the target obstacle in the last cycle as the residual vector between the motion information and the motion information of the target obstacle in the last cycle.

18. The apparatus according to claim 15, wherein the determining, for each type of motion information in the determined M types of motion information, a residual vector between the motion information and motion information of the target obstacle in a last cycle comprises:
executing for each type of motion information in the determined M types of motion information: generating estimated motion information of the target obstacle using the preset filtering algorithm with the motion information of the target obstacle as a state variable, and the motion information as an observed amount; and determining a differential vector between the generated estimated motion information and the motion information of the target obstacle in the last cycle as the residual vector between the motion information and the motion information of the target obstacle in the last cycle.

19. The apparatus according to claim 14, wherein the operations further comprise:
calculating a second observed displacement of the target obstacle corresponding to a second observed displacement amount in each of N second observed displacement amounts based on the obstacle point cloud in the current frame and the obstacle point cloud in the reference frame in response to determining the determined M types of motion information being ambiguous, wherein the calculation amount of the second observed displacement amount in the each of the N second observed displacement amounts is greater than the calculation amount of the first observed displacement amount in the each of the M first observed displacement amounts;
determining motion information of the target obstacle corresponding to the second observed displacement amount in the each of the N second observed displacement amounts based on N second observed displacements obtained through calculation and the sampling period of the lidar;
determining the observed motion information of the target obstacle in accordance with the kinematic rule or the statistical rule based on the determined N types of motion information, the determined M types of motion information and the historical motion information of the target obstacle.

20. The apparatus according to claim 19, wherein before the generating current motion information of the target obstacle using a preset filtering algorithm with the motion information of the target obstacle as a state variable, and the observed motion information as an observed amount, the operations further comprise:
determining whether the modulus of a residual vector between the observed motion information and the motion information of the target obstacle in the last cycle is greater than a third preset modulus threshold; and
updating the observed motion information using motion information obtained through multiplying the observed motion information by a first ratio in response to determining the modulus of the residual vector between the observed motion information and the motion information of the target obstacle in the last cycle being greater than the third preset modulus threshold, wherein the first ratio is obtained through dividing the third preset modulus threshold by the modulus of the residual vector between the observed motion information and the motion information of the target obstacle in the last cycle.

21. The apparatus according to claim 20, wherein the generating current motion information of the target obstacle using a preset filtering algorithm with the motion information of the target obstacle as a state variable, and the observed motion information as an observed amount comprises:
adjusting a filtering parameter in the preset filtering algorithm based on a similarity between the obstacle point cloud in the current frame and the obstacle point cloud in the reference frame; and
generating current motion information of the target obstacle using the preset filtering algorithm with the adjusted filtering parameter with the motion information of the target obstacle as a state variable, and the observed motion information as an observed amount.

22. The apparatus according to claim 21, wherein the motion information comprises at least one of: speed information, or acceleration information.

23. The apparatus according to claim 22, wherein the M first observed displacement amounts comprise at least one of: an observed center displacement amount, an observed gravity center displacement amount, an observed edge center displacement amount, or an observed corner displacement amount.

24. The apparatus according to claim 23, wherein the N second observed displacement amounts comprise an observed surface displacement amount.

25. A non-transitory computer-readable storage medium storing a computer program, the computer program when executed by one or more processors, causes the one or more processors to perform operations, the operations comprising:
acquiring an obstacle point cloud in a current frame and the obstacle point cloud in a reference frame characterizing a target obstacle with to-be-generated motion information, wherein the obstacle point cloud in the current frame is obtained based on a current laser point cloud frame collected by the lidar, and the obstacle point cloud in the reference frame is obtained based on a laser point cloud characterizing the target obstacle in a preset number of laser point cloud frames prior to the current laser point cloud frame collected by the lidar;
calculating a first observed displacement of the target obstacle corresponding to a first observed displacement amount in each of M first observed displacement amounts based on the obstacle point cloud in the current frame and the obstacle point cloud in the reference frame;
determining motion information of the target obstacle corresponding to the first observed displacement amount in the each of the M first observed displacement amounts based on M first observed displacements obtained through calculation and a sampling period of the lidar;
determining observed motion information of the target obstacle in accordance with a kinematic rule or a statistical rule based on the determined M types of motion information and historical motion information of the target obstacle; and
generating current motion information of the target obstacle using a preset filtering algorithm with the motion information of the target obstacle as a state variable, and the observed motion information as an observed amount.
